(19) United States
(12) Patent Application Publication
(10) Pub. No.: US 2014/0129466 A1
(43) Pub. Date: May 8, 2014

(54) METHOD AND SYSTEM FOR SELECTING LABOUR RESOURCES

(71) Applicant: BCD Group Labour Logistics Pty Ltd, Sumner Park, Queeenland (AU)

(72) Inventor: Michael Robert Ott, Summer Park (AU)

(21) Appl. No.: 14/119,005

(22) PCT Filed: May 18, 2012
(86) PCT No.: PCT/AU2012/000553

§ 371 Date: Jan. 23, 2014

(30) Foreign Application Priority Data
May 23, 2011 (AU) 2011901992

(51) Int. Cl. G06Q 10/10

(52) U.S. Cl. CPC G06Q 10/1053
USPC 705/321

(57) ABSTRACT

A method of selecting a candidate for a job including the steps of: receiving at a server at least one candidate profile from at least one candidate; receiving at the server at least one job description for a job from an employer; processing at the server the at least one candidate profile and the at least one job description; determining at the server a most compatible candidate profile or profiles from the candidate profile or profiles and the job description; and transmitting the most compatible candidate profile or profiles to the employer.

### FIELD OF THE INVENTION

This invention relates generally to a method and system for selecting labour resources. In particular, the invention relates to a method and system for selecting a candidate for a job.

### BACKGROUND OF THE INVENTION

Many employers need staff on a casual or short-term basis such as in the construction industry and usually at short notice. However, specialised trades require certain expertise and for staff to hold certain accreditations. For example all construction workers in Queensland, Australia must have a White Card in order to work on a construction site.

In order to determine whether a candidate is suitable for a particular job, it is necessary for a recruitment agent to manually compare a candidate profile with job requirements. However, manually comparing a candidate profile with job requirements can be time consuming and therefore costly to perform. In addition, this manual comparison can be prone to error. For example, prime candidates may be overlooked or missed.

Some employers need several candidates to perform a particular job. For example, a builder may need several bricklayers. At present, manual systems exist to manage the candidates, for example using a calendar. However, again, such manual systems are prone to error and are difficult to follow.

There is therefore a need for an improved method and system for selecting labour resources.

### OBJECT OF THE INVENTION

It is an object of some embodiments of the present invention to provide consumers with improvements and/or advantages over the above described prior art, and/or overcome and alleviate one or more of the above described disadvantages of the prior art, and/or provide a useful commercial choice.

### SUMMARY OF THE INVENTION

In one form, although not necessarily the only or broadest form, the invention resides in a method of selecting a candidate for a job including the steps of:

receiving at a server at least one candidate profile from at least one candidate; receiving at the server at least one job description for a job from an employer;

processing at the server the at least one candidate profile and the at least one job description;

determining at the server a most compatible candidate profile or profiles from the candidate profile or profiles and the job description; and transmitting the most compatible candidate profile or profiles to the employer.

Preferably, the method includes transmitting to the employer a plurality of job status icons concerning a plurality of jobs for simultaneous display to the employer.

Preferably the method includes the step of receiving at the server one or more identifications of candidates selected by the employer.

Preferably the method includes the step of notifying the selected candidate or candidates. Preferably the method includes the step of receiving a confirmation from the selected candidate or candidates.

Preferably, the method includes the step of transmitting a job status for viewing by the employer.

Preferably, the job status indicates when a requisite number of candidates have been confirmed as being assigned to the job.

Preferably, the candidate profile includes one or more of public data and private data.

Preferably, the private data cannot be viewed by the employer.

Preferably, the candidate profile includes a rating provided by at least one previous employer.

Preferably, candidates are sorted according to the rating.

Preferably, the rating cannot be viewed by the candidate.

Suitably, the candidate profile includes one or more of a certification, a photo, a qualification, a geographical area, an experience level, an availability and an asking salary.

Preferably the asking salary cannot be viewed by the employer.

Preferably, the job description includes an overview, a certification requirement, a qualification requirement, a job salary and a geographical location.

Preferably, the job salary cannot be viewed by the candidate.

In another form, the invention resides in a system for selecting a candidate for a job including:

a server connected to the internet, the server including:

a memory coupled to a processor, wherein the memory includes computer readable program code components configured to cause:

receiving at least one candidate profile from at least one candidate;

receiving at least one job description for a job from an employer;

processing the at least one candidate profile and the at least one job description;

determining a most compatible candidate profile or profiles from the candidate profile or profiles and the job description; and

transmitting the most compatible candidate profile or profiles to the employer.

Preferably, the program code components include the step of transmitting to the employer a plurality of job status icons concerning a plurality of jobs for simultaneous display to the employer.

Preferably the program code components include the step of receiving one or more identifications of candidates selected by the employer.

Preferably the program code components include the step of notifying the selected candidate or candidates.

Preferably the program code components include the step of receiving a confirmation from the selected candidate or candidates.

Preferably, the program code components include the step of transmitting a job status for viewing by the employer.

### BRIEF DESCRIPTION OF THE DRAWINGS

An embodiment of the invention will be described with reference to the accompany drawings in which:

FIG. 1 is a block diagram illustrating a system for selecting labour resources according to an embodiment of the present invention;

FIG. 2 is a flow diagram showing the steps of a method of selecting labour resources according to an embodiment of the present invention;

FIG. 3 is a screen shot of a job management page according to an embodiment of the present invention;

FIG. 4 shows a screen shot of a job status page according to an embodiment of the present invention;

FIG. 5 shows a screen shot of a job record page according to an embodiment of the present invention;

FIG. 6 shows a screen shot of candidate search page according to an embodiment of the present invention;

FIG. 7 shows a screen shot of a search result page according to an embodiment of the present invention;

FIG. 8 shows a screen shot of a candidate profile page according to an embodiment of the present invention;

FIG. 9 shows a screen shot of a recent candidates page according to an embodiment of the present invention;

FIG. 10 shows a screen shot of a timesheet page according to an embodiment of the present invention; and

FIG. 11 shows a screen shot of an invoice page according to an embodiment of the present invention.

### DETAILED DESCRIPTION OF THE PREFERRED EMBODIMENT

Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element from another element without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention. It will be appreciated that the invention may be implemented in a variety of ways, and that this description is given by way of example only.

The reference to any prior art in this specification is not, and should not be taken as, an acknowledgement or any form of suggestion that the prior art forms part of the common general knowledge.

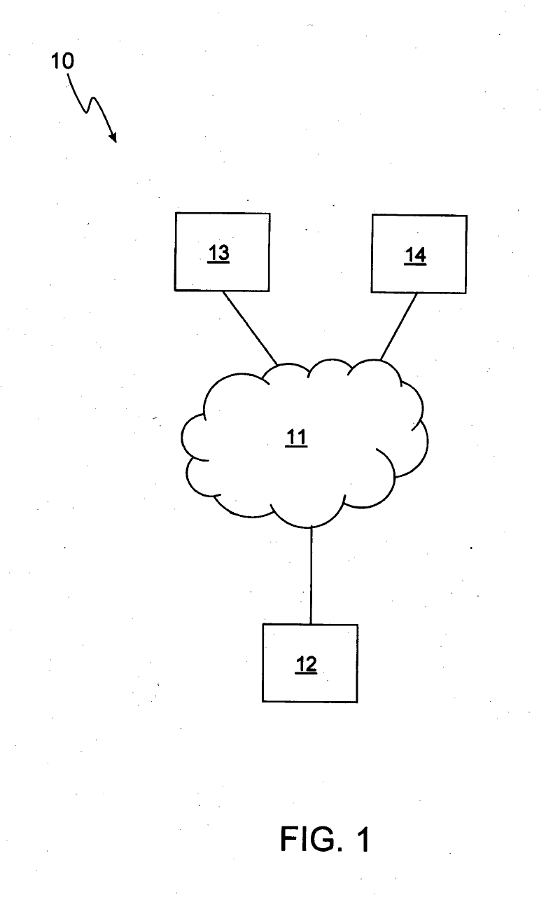

FIG. 1 is a block diagram showing a system 10 for selecting a candidate for a job, according to some embodiments of the present invention. A computer in the form of a server 12 is connected to the Internet 11, to which users, such as a candidate 13 and an employer 14, have access. The users may access the server 12 using a web browser. The server 12 includes a memory coupled to a processor, and the memory includes computer readable program code components. The program code components are in the form of software installed on a computer readable medium, for example on a hard disk, a random access memory (RAM), or any other applicable computer readable medium. The program code components perform the method of the present invention.

The present invention allows employers 14 to select a candidate 13, or candidates 13, for a job via the server 12 over the Internet 11. The server 12 is controlled by a managing entity, such as a recruitment agency. The managing entity may charge a fee to the employer 14 for access to the server 12.

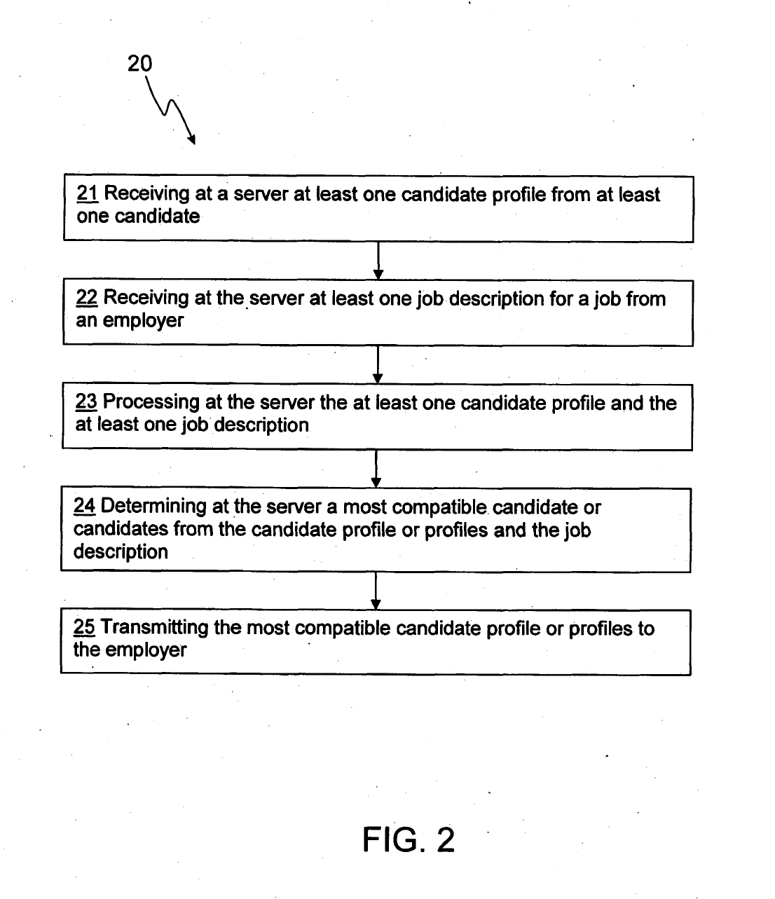

FIG. 2 is a flow diagram showing the steps of a method of selecting a labour resource according to an embodiment of the present invention. At step 21 candidate profiles are received by the server 11, which has been entered by a candidate 13 using a web browser.

Similarly, at step 22, the server 11 receives a job description relating to a job the employer 14 has on offer, which has been entered by an employer using a web browser. At step 23, the candidate profiles and the job description are processed by the server and at step 24, the most compatible candidate profiles to the job description are determined.

At step 25, the most compatible candidate profiles are transmitted to the employer 14, and the employer 14 selects which candidate 13 or candidates 13 to use for a particular job.

An advantage of the present invention is that the candidates 13 are automatically determined rather than an employer having to manually correlate candidate profiles to a particular job. Furthermore, it is less likely that a potential candidate 13 may get overlooked by the employer 14. Prior to using the system 10, employers 14 and candidates 13 register by accessing a web site using a web browser.

In order to register, employers 14 create an employer profile. The employer profile may include, but is not limited to, a company name, a contact name, an address, a phone number, an email address, a company number, a business number, a login name and a password. However a person skilled in the art will appreciate that other details may be provided.

Similarly, a candidate 13 may register by accessing a web site using a web browser. By registering, a candidate 13 completes a candidate profile.

The candidate profile may include private data and public data. The public data is visible to employers and may include, but is not limited to a name, an address, a telephone number and a photo, qualifications, certifications, an availability and a geographical area. The geographical area defines where the candidate is prepared to work. The geographical area may include regions, suburbs, postcodes or a radius from a specific location.

The private data cannot be viewed by an employer 14 and may include tax details, bank account details and an asking salary and other private data. It should be appreciated, that the managing entity may determine which data is private.

Optionally, before the candidate 13 is able to log into the system 10, the candidate profile may be vetted by the managing entity. Once the, managing entity accepts a candidate 13, an email may be sent to the candidate 13 informing them that their application has been successful and confirm their login details and password. Alternatively, the login details and password may form part of the private data of the candidate's profile.

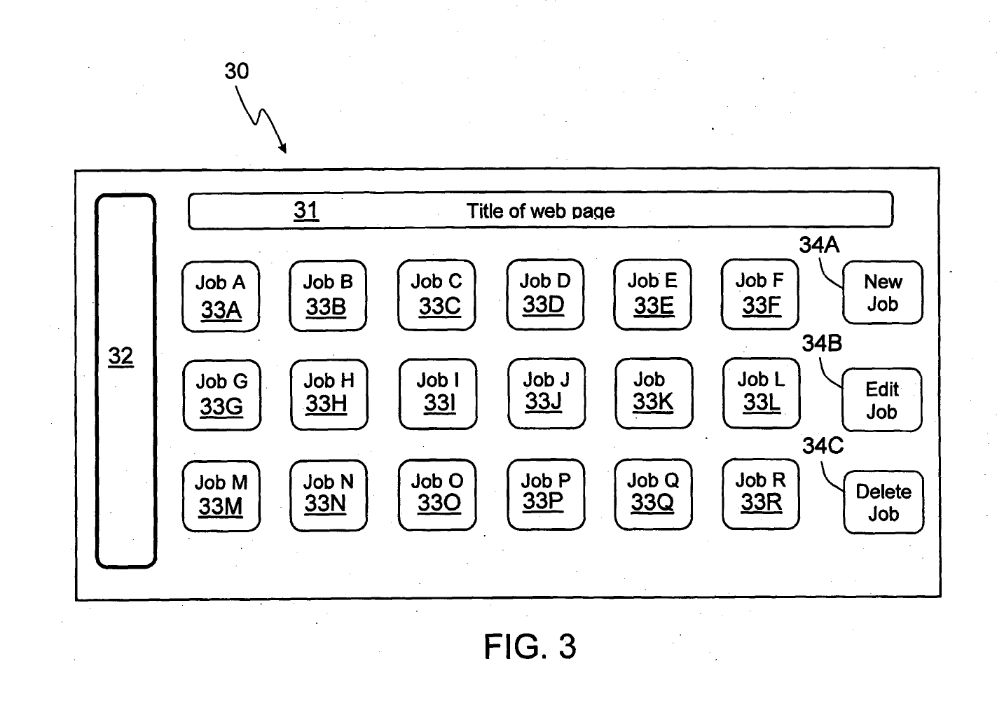

Once an employer 14 has registered, the employer 14 may log in using a user name and password. Once logged in, the employer 14 can manage jobs they have available as shown in FIG. 3. FIG. 3 is a screen shot of a job management page 30 according to an embodiment of the present invention. The job management page 30 includes a title 31 and navigation buttons 32. The navigation buttons 32 allow a user to navigate the website of the present invention as would be understood by a person skilled in the art.

The job management page 30 also includes job icons 33A . . . 33R relating to jobs an employer has to offer. Although eighteen job icons 33A . . . 33R are shown it should be appreciated that the number of job icons 33A . . . 33R relates to the number of jobs the employer has to offer.

In order to create a new job icon 33A . . . 33R, the employer 14 may click on a new job button 34A. Furthermore an existing job may be edited by clicking on a job icon 33A . . . 33R, to highlight the job icon 33A . . . 33R, and clicking on an edit job button 34B to edit the job. Similarly, jobs may be deleted by highlighting a job icon 33A . . . 33R and clicking a delete job button 34C.

When creating or editing a job, the employer 14 enters job requirements, including, but not limited to, an overview, a location, a qualification required, a certification required, an experience level, and a job salary. Other job requirements may be entered depending on a type of job, such as tools needed for a job. For example a plasterer may need to supply a plastering trowel.

The job salary is a maximum amount the employer 14 is prepared to pay to the managing entity for a candidate 13, should the candidate 13 be selected. In one embodiment, the maximum salary includes the candidate's salary plus all taxes and all associated employment expenses and a commission paid to the managing entity. The job salary cannot be seen by the candidate 13. In an alternative embodiment, the employer 14 may contact the candidate 13 directly, in which case, the employer may pay a percentage of the salary paid to the candidate 13 to the managing entity.

In one embodiment, once a job has been entered by the employer 14, the server 12 determines a most compatible candidate profile or profiles from the candidate profile or profiles and the job description. Once the most compatible candidates have been determined, the. server 12 returns an identification of the most compatible profile or profiles for viewing by the employer 14. In one embodiment only candidates 13 whose asking salary is less than the job salary minus all taxes and all associated employment expenses and a commission paid to the managing entity, are displayed to the employer 14.

Alternatively, as explained later, the employer may perform a manual search for a candidate 13.

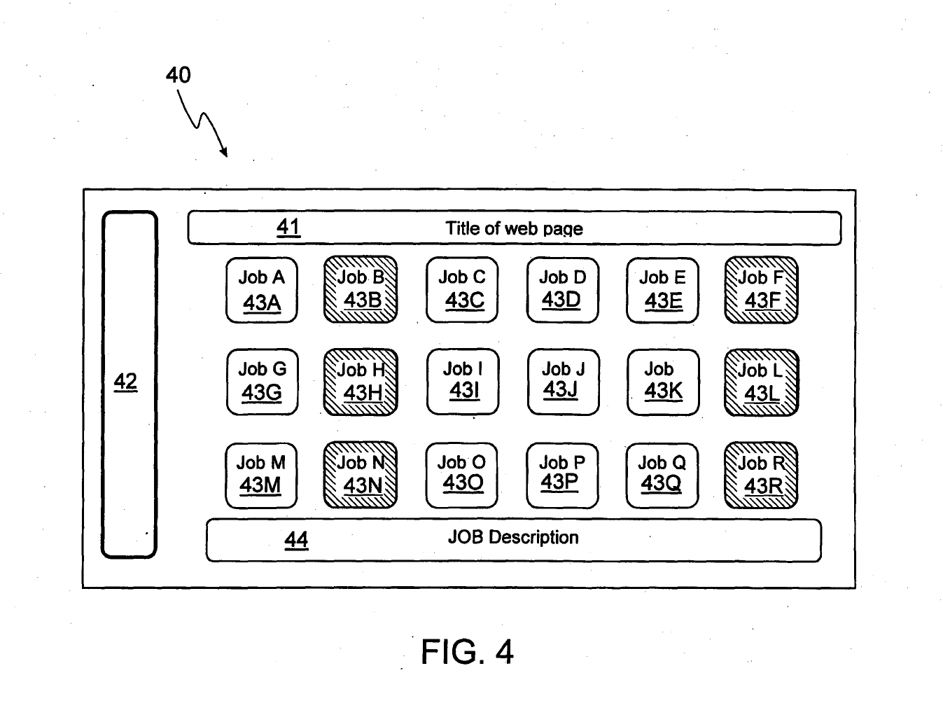

FIG. 4 shows a screen shot of a job status page 40 according to an embodiment of the present invention. Similarly to the job management page 30 of FIG. 3, the job status page 40 includes a title 41 and navigation buttons 42.

The job status page also includes a plurality of job status icons 43A . . . 43R for simultaneous display to the employer 14. The job status icons 43A . . . 43R indicate if a job has been allocated a requisite number of candidates 13. It should be appreciated that a job may require one candidate 13 or more than one candidate 13. In the embodiment of FIG. 4, Job B 43B, Job F 43F, Job H 43H, Job L 43L, Job N 43N and Job R 43R are highlighted thus indicating that those jobs have been allocated with the requisite number of candidates 13.

In addition, by clicking on a job status icon 43A . . . 43R, the job description may be viewed in a job description box 44. The job description lists details of the job that were entered in the job management page 30. Parts of the job description which have not been hidden, for example a salary and a rating, may also be viewed by candidates using a separate web page.

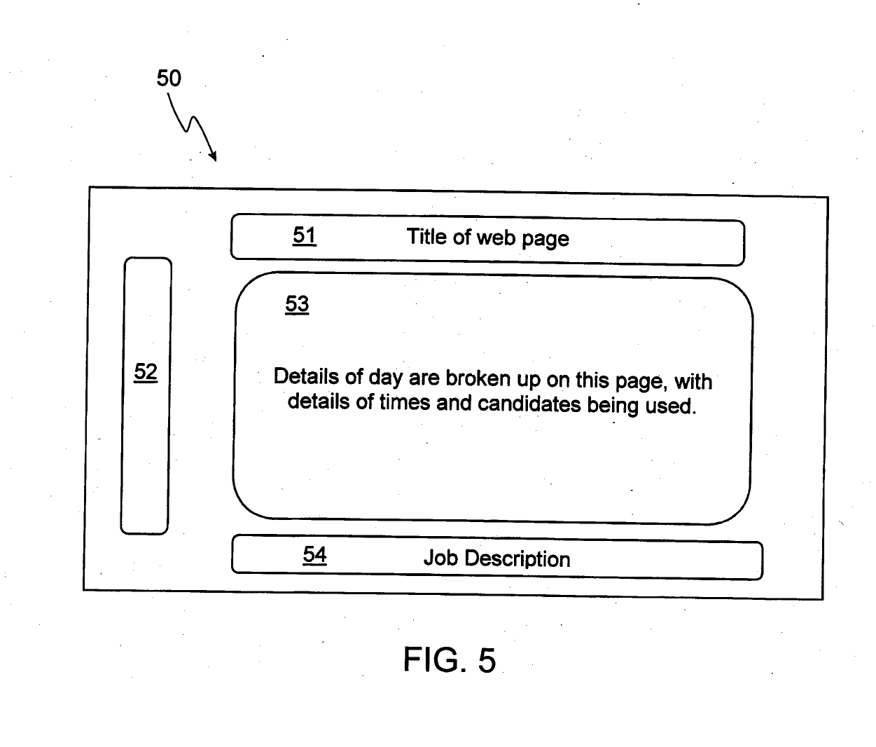

An employer 14 may view details of a job on a specific day by double clicking on a job status icon 43A . . . 43R as shown in FIG. 5. FIG. 5 shows a screen shot of a job record page 50 according to an embodiment of the present invention. Similarly to previous pages, the job record page 50 includes a title 51 and navigation buttons 52. The job record page 50 may show a calendar 53 which details each candidate 13 being used for a particular job, together with start and finish times for each candidate 13 selected for the job. The candidates 13 may start and finish at different times of day according to the employer's requirements. Similarly to the job status page 40, a job description box 54 shows details of the selected job.

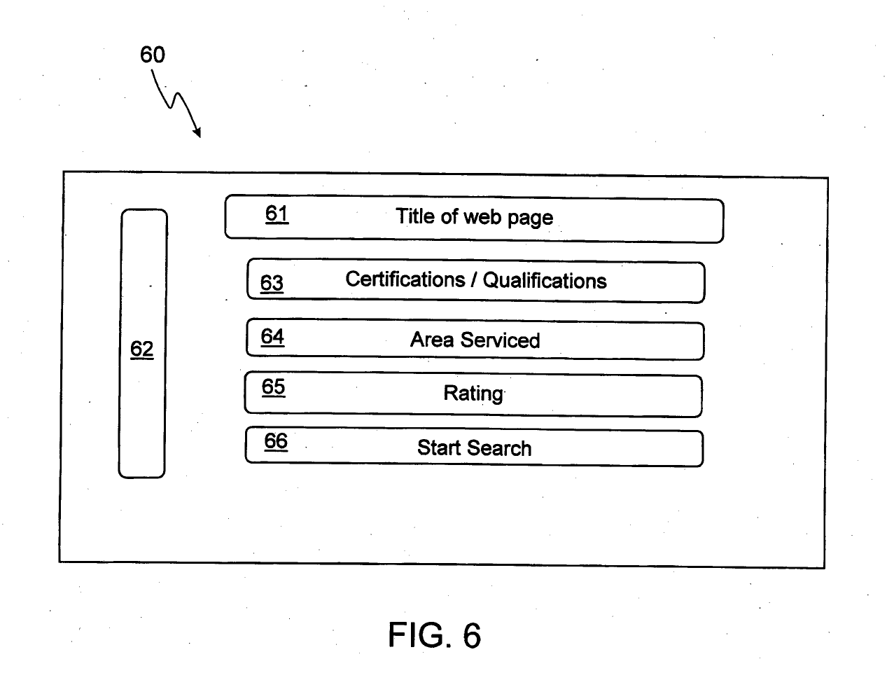

An employer may search for a suitable candidate 13 or candidates 13 using a candidate search page. FIG. 6 shows a screen shot of candidate search page 60 according to an embodiment of the present invention. Like previous pages, the candidate search page 60 includes a title 61 and navigation buttons 62.

In order to perform a candidate search, the employer 14 enters search terms into fields. The fields may include certifications/qualifications 63, a geographical area 64, and a rating 65. It should be appreciated that other fields may be included depending on the job. The rating of a candidate 14 is provided by previous employers 14 and may include factors such as timeliness and quality of work and cannot be seen by the candidate 13. Once the employer 14 has populated all or some of the fields, the employer 14 clicks on a start search button 66. The server 12 processes the candidate profiles and the job description and determines a most compatible candidate 13 or candidates 13 from the candidate profile or profiles and the job description. The server 12 then transmits an identification of the most compatible candidate 13 or candidates 13 determined by the server 12 as the most closely matched candidate profiles with the job description for displaying to the employer 14.

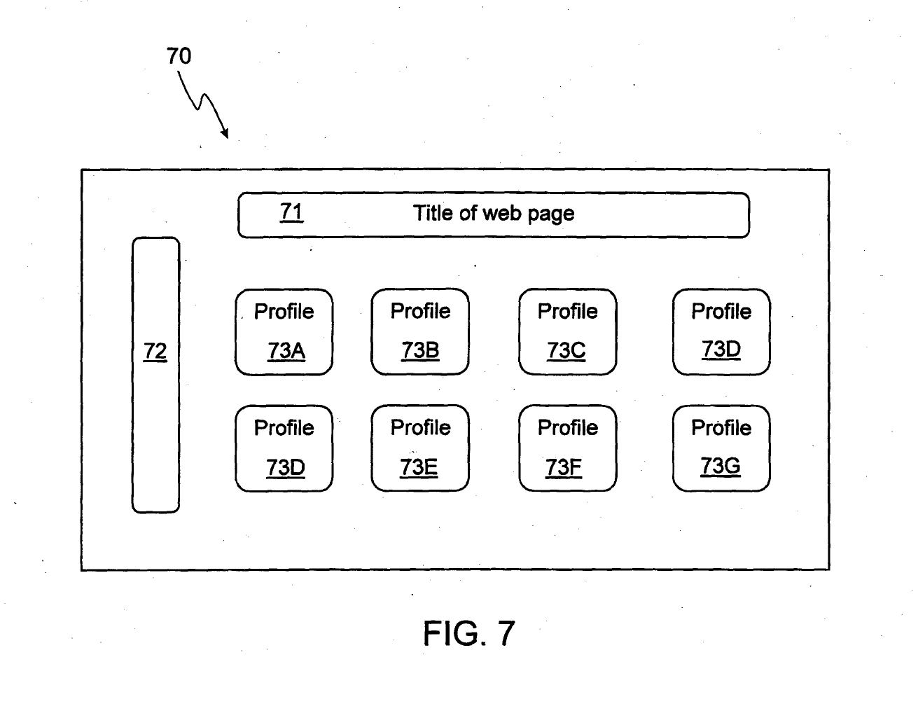

FIG. 7 shows a screen shot of a search result page 70 according to an embodiment of the present invention. As for previous pages, the search result page 70 includes a title 71 and navigation buttons 72.

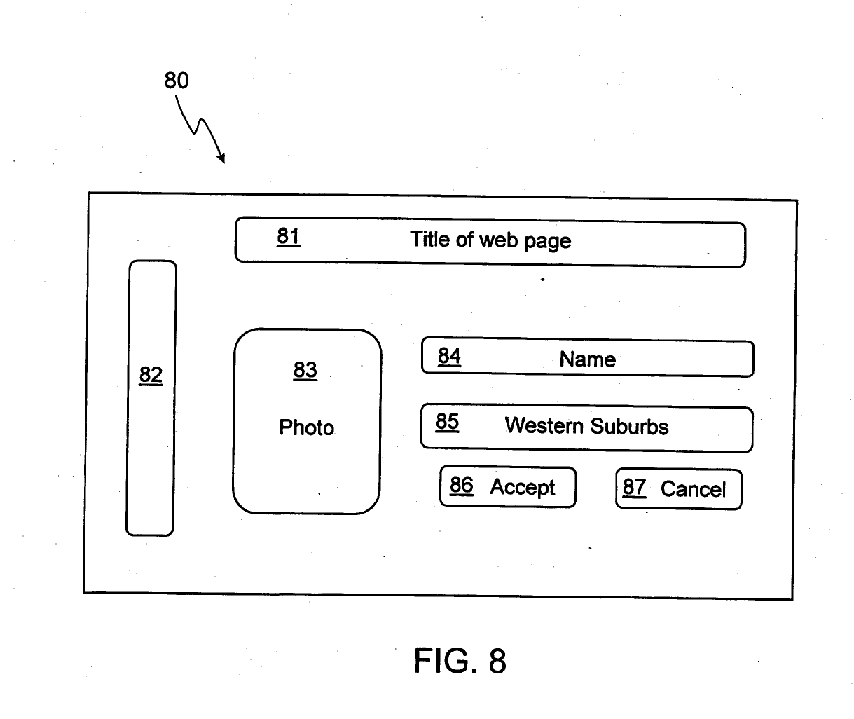

The search result page 70 also includes a plurality of candidate profile icons 73A . . . 73G that match the search criteria entered in the candidate search page 60 of FIG. 6. The employer 14 may double click on any of the candidate profile icons 73A . . . 73G in order to view the candidate's 13 profile and is presented with a detailed candidate profile as shown in FIG. 8.

FIG. 8 shows a screen shot of a candidate profile page 80 according to an embodiment of the present invention. The candidate profile page 80 includes a title 81 and navigation buttons 82.

The candidate profile page 80 also includes a photo 83 of the candidate 13, a name 84 and a geographical area 85. In order to offer the job to the candidate 13, the employer 14 may click an accept button 86, or press a cancel button 87 if the employer 14 does not want to offer the job to the candidate 13. The employer 14 may select any number of candidates 13 as required.

When the employer 14 offers a job to a candidate 13, the server 12 sends a job offer to the candidate 13. The job offer may be sent via email, SMS or by any other applicable medium. When the job offer is received by the candidate 13, the candidate 13 sends a job acceptance to the employer. The job acceptance may be an SMS, an email or by the candidate logging into their account. Alternatively, the candidate 13 may contact the managing entity to accept the job.

Once the candidate 13 has performed the job, the employer 14 provides a rating which may be viewed by employers in order to aid the selection process. Additionally, the employer 14 may provide a written review.

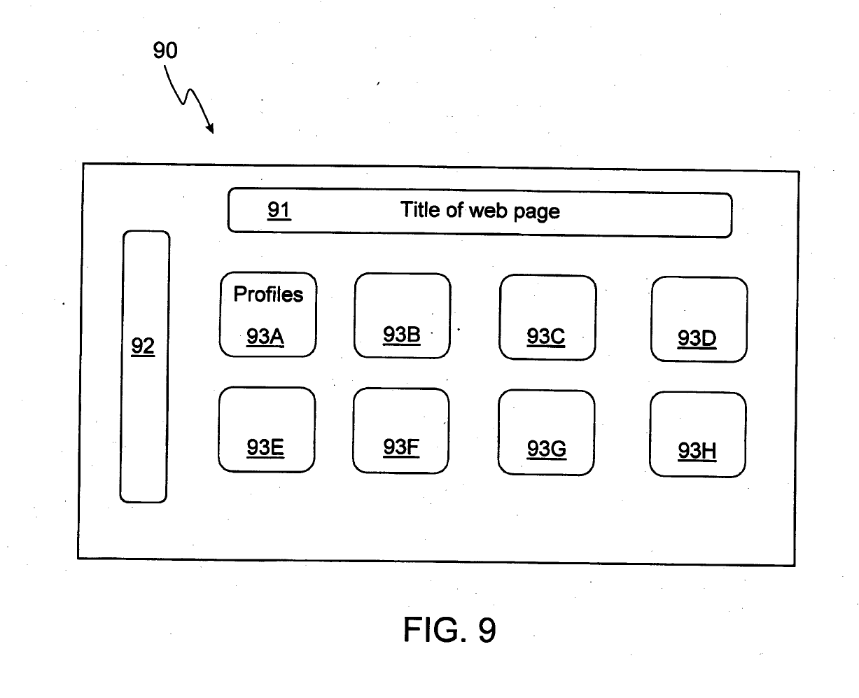

The employer 14 may view profiles of previously used candidates as shown in FIG. 9. FIG. 9 shows a screen shot of a recent candidates page 90 according to an embodiment of the present invention. In addition to a title 91 and navigation buttons 92, the recent candidates page 90 includes recent candidate icons 93A . . . 93H. The employer 14 may click on a recent candidate icon 93A . . . 93H in order to view the candidate's profile in detail. In addition the employer 14 may provide a rating for the candidate 13 as previously described or the employer 14 may write a written review which may be viewed by other employers 14 and may count towards the rating.

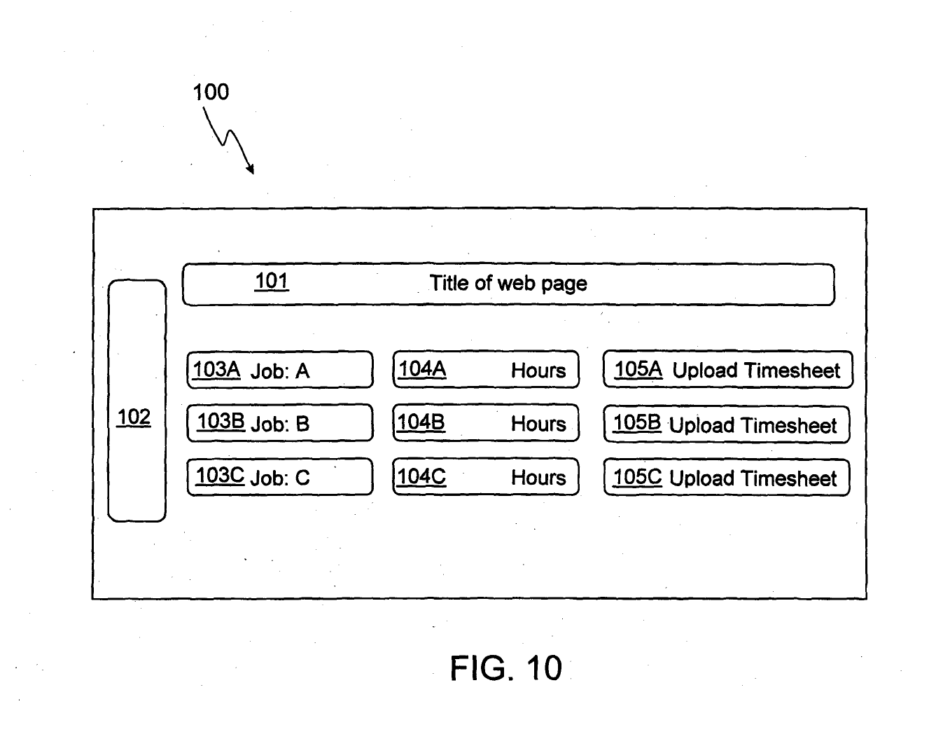

Once the candidate 13 has completed a job for the employer 14, the employer 14 signs a physical timesheet which the candidate 13 uploads using a timesheet page as shown in FIG. 10. FIG. 10 shows a screen shot of a timesheet page 100 according to an embodiment of the present invention. The timesheet page 100 includes a title 101 and navigation buttons 102.

The timesheet page 100 also includes a plurality of job identifications (IDs) 103A . . . 103C and corresponding hours worked buttons 104A . . . 104C and upload buttons 105A . . . 105C. The candidate 13 presses an hours worked button 104A . . . 104C corresponding with the job ID 103A . . . 103C and types in the number of hours worked. In order to upload a timesheet, the candidate 13 clicks on a corresponding upload timesheet button 105A . . . 105C.

The server 12 calculates the candidate's salary from the hours worked and entered by the candidate and also a cost to the employer. The candidate 13 is then payed by the managing entity, either automatically, or manually.

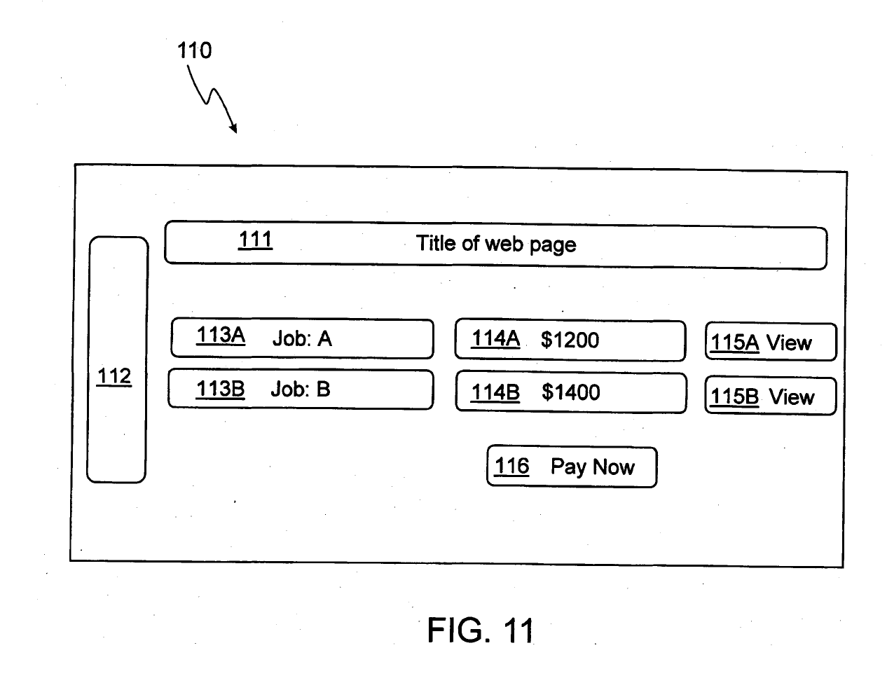

The employer 14 may view an amount charged for a candidate 13 and timesheets entered by candidates by navigating to an invoice page. FIG. 11 shows a screen shot of an invoice page 110 according to an embodiment of the present invention. Similarly to previous pages, the invoice page 110 includes a title 111 and navigation buttons 112. In addition, the invoice page 110 includes job identifications 113A, 113B, a corresponding cost 114A, 114B and view buttons 115A, 115B so that an employer 14 can view a corresponding timesheet. The employer 14 may pay for the cost of the candidate 13 using a pay now 116 button.

Some advantages of the present invention include:

1) The most compatible candidates for a job are determined quickly, and therefore the cost is reduced compared to systems that manually provide the labour services comparisons;

2) The most compatible candidates for a job are less likely to be overlooked; and

3) A direct link is provided between the employer and the candidate reducing the time to find suitable candidates for a job.

It should be appreciated that although reference is made to jobs relating to the building industry, various alternative embodiments of the present invention may be applied to any applicable industry such as, but not limited to, Information Technology, hospitality, domestic services, agriculture, professional services, sales and mining.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A method of selecting a candidate for a job including the steps of: receiving at a server at least one candidate profile from at least one candidate;
receiving at the server at least one job description for a job from an employer;
processing at the server the at least one candidate profile and the at least one job description;
determining at the server a most compatible candidate profile or profiles from the candidate profile or profiles and the job description; and transmitting the most compatible candidate profile or profiles to the employer.

2. The method of claim 1 including the step of transmitting to the employer a plurality of job status icons concerning a plurality of jobs for simultaneous display to the employer.

3. The method of claim 2 including the step of receiving at the server one or more identifications of candidates selected by the employer.

4. The method of claim 2 including the step of notifying the selected candidate or candidates.

5. The method of claim 4 including the step of receiving a confirmation from the selected candidate or candidates.

6. The method of claim 1 including the step of transmitting a job status for viewing by the employer.

7. The method of claim 6 wherein the job status indicates when a requisite number of candidates have been confirmed as being assigned to the job.

8. The method of claim 1 wherein the candidate profile includes one or more of public data and private data.

9. The method of claim 8 wherein the private data cannot be viewed by the employer.

10. The method of claim 1 wherein the candidate profile includes a rating provided by at least one previous employer.

11. The method of claim 10 wherein candidates are sorted according to the rating.

12. The method of claim 10 wherein the rating cannot be viewed by the candidate.

13. The method of claim 1 wherein the candidate profile includes one or more of a certification, a photo, a qualification, a geographical area, an experience level, an availability and an asking salary.

14. The method of claim 13 wherein the asking salary cannot be viewed by the employer.

15. The method of claim 1 wherein the job description includes an overview, a certification requirement, a qualification requirement, a job salary and a geographical location.

16. The method of claim 15 wherein the job salary cannot been viewed by the candidate.

17. A system for selecting a candidate for a job including:
a server connected to the internet, the server including:
a memory coupled to a processor, wherein the memory includes computer readable program code components configured to cause: receiving at least one candidate profile from at least one candidate; receiving at least one job description for a job from an employer; processing the at least one candidate profile and the at least one job description;
determining a most compatible candidate profile or profiles from the candidate profile or profiles and the job description; and
transmitting the most compatible candidate profile or profiles to the employer.

18. The system of claim 17 wherein the program code components include the step of transmitting to the employer a plurality of job status icons concerning a plurality of jobs for simultaneous display to the employer.

19. The system of claim 18 wherein the program code components include the step of receiving one or more identifications of candidates selected by the employer.

20. The system of claim 19 wherein the program code components include the step of notifying the selected candidate or candidates.
